(19) United States
(12) Patent Application Publication
(10) Pub. No.: US 2009/0223108 A1
(43) Pub. Date: Sep. 10, 2009

(54) Swimming softbait lure

(76) Inventors: Albin Andrew Hastbacka, W. Chatham, MA (US); Alan Andrew Hastbacka, W. Chatham, MA (US)

Correspondence Address: Albin Hastbacka, PO Box 112, W. Chatham, MA, 02669, US

(21) Appl. No.: 12/380,936

(22) Filed: Mar. 5, 2009

Related U.S. Application Data
(60) Provisional application No. 61/068,711, filed on Mar. 10, 2008.

(51) Int. Cl. A01K 85/00; A01K 85/01

(52) U.S. Cl. 43/17.6; 43/42.24

(57) ABSTRACT

An artificial fishing lure has an integral elongate, asymmetrical body of soft, resilient material which has ellipsoidal cuts on opposing sides of the body to create living hinges between segments of the body. Use of a plurality of hinges in conjunction with spoilers on alternating segments allows independent movement of different segments of the lure. Spoilers on alternating body segments combined with the living hinges creates a serpentine movement of the lure when drawn through water. The lure acts as a lossy fiber optic when made of a transparent or translucent material, so that light entering the lure exits at the hinges and the tail to act as a fish attractant.

### CROSS-REFERENCE TO RELATED APPLICATIONS

U.S. Provisional Application No. 61/068,711, entitled “Swimming Softbait Lure” filed on Mar. 10, 2008, the disclosure of which is incorporated herein by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Field of Invention

This invention relates generally to artificial lures and deals more particularly with a flexible artificial lure designed to take advantage of predator fish's recognized or perceived abilities to target bait that moves with a serpentine motion, vortex generated behind the moving target bait, or modulated reflected light pattern.

2. Background Art

Conventional fishing lure designs usually incorporate shapes that use water resistance to impart some form of action or movement to the lure body. Example shapes are lips that cause the lures to descend as they are pulled through the water; spinners that turn in reaction to the forward progress of the lure; curved or flattened tails that ripple when straightened out by water resistance, appendages, etc. Such design factors in the various shapes, while enhancing body movement, impart a rhythm that contrasts with the random movements of bait fish trying to avoid their predators. While the body of a typical fishing lure moves, bends, vibrates or ripples, the devices which create these movements also tend to provide a directional stability that is not typical of the movements of frightened or injured prey and to which random movements predatory fish respond most readily to.

The present invention utilizes a balanced, streamlined design purposely devoid of such stabilizing features to eliminate directional stability. This lack of stability allows the lure, as it is moved through or over the water, to move in an overall erratic serpentine path, as opposed to the directional path of conventional lures. This random movement more accurately mimics the movements of frightened prey. The balance of the preferred configuration of the present invention is such that the lure is free to move in random directions, as opposed to the “head first” motion of conventional lures.

Another general problem associated with the design of artificial plastic fishing lures is their inability to function both on and beneath the surface of the water. Thus, a fisherman generally will need to change lures to accommodate above or below surface fishing.

An independent comparison of lures made according to the present invention and ones made according to U.S. Pat. No. 4,998,372 was found. The surprising result of this comparison¹ showed that the present invention had a significantly higher success rate in catching striped bass in the Cape Cod Canal.

### SUMMARY OF THE INVENTION

In accordance with the invention, an artificial fishing lure is presented and comprises an elongate, asymmetrical, resilient body with a plurality of hinges, which provide flexure about an axis. Although hinged, the lure has a continuous, integral body.

In its preferred embodiment, the lure has two or more opposing concave ellipsoidal cuts to form hinges each of which allow for flexure along an axis. The use of a plurality of hinges in conjunction with spoilers on alternating segments allows for independent movement of different segments of the lure.

### OBJECTS AND ADVANTAGES

Accordingly, several objects and advantages of the present invention are:

(a) to provide an artificial lure that substantially overcomes the above and other problems associated with known artificial fishing lures;

(b) to provide an artificial lure which moves in an erratic serpentine manner when pulled under and on the surface of the water, thereby creating the impression of a swimming eel or frightened wounded bait fish.

(c) to provide a multi plane lure which can be used both on the surface and under the surface of the water;

(d) to provide a lure that can be varied in size, dimension, and color to resemble and thus attract a variety of fishes; and

(e) to provide a sinking type fishing lure with which surface tension can be used to float the lure on the surface of the water.

(f) testing of the invention to catch striped bass was done by an independent third party as described in Attachment A. Attachment A compares the relative success of fishing with the invention as compared to fishing with a bait made according to U.S. Pat. No. 4,998,372.

### BRIEF DESCRIPTION OF SEVERAL VIEWS OF THE DRAWING

FIG. 1 is a perspective view of a preferred embodiment of the artificial fishing lure of the invention.

FIG. 2 is a cross-sectional view of ellipsoidal concave cuts to form hinges of the embodiment of FIG. 1 taken along the horizontal axis.

FIG. 3 is a side view of the embodiment of FIG. 1 with a hook in place as the lure lies on a surface.

FIG. 4 is a top view showing compound flexure of a preferred embodiment.

### DETAILED DESCRIPTION

FIG. 1 shows the artificial fishing lure of the present invention wherein the lure is generally designated 10 and includes a multi-segmented, continuous non-stabilized, integral body 12 having ellipsoidal concave cut surfaces 20 on opposing sides. The lure 10, as shown, has a plurality of segments including leading and trailing segments and a medial portion 16. The body 12 increases in size from the leading terminal end 15 toward the medial portion 16, with the tallest and broadest cross section forward of the center. Hinges 40, 40, couple the medial portion 16 to the leading and trailing segments. When the lure is retrieved through water, spoilers 47 on alternating segments create a transverse force causing alternating segments to turn in opposing directions. The body 12 decreases in size from the medial portion 16 to the trailing terminal end 17. The leading portion of the lure has a high volume per unit length ratio, thus offsetting the weight of the hook and maintaining the near perfect balance that is integral to the lure's non stable movement.

The recesses in the body 12 generally designated 20, 20 and which are created as part of the hinges 40, 40 trap and release air bubbles as the lure bends and swims in the water. The recesses 20, 20 also exaggerate the effect of the spoilers in creating a side-to-side serpentine motion.

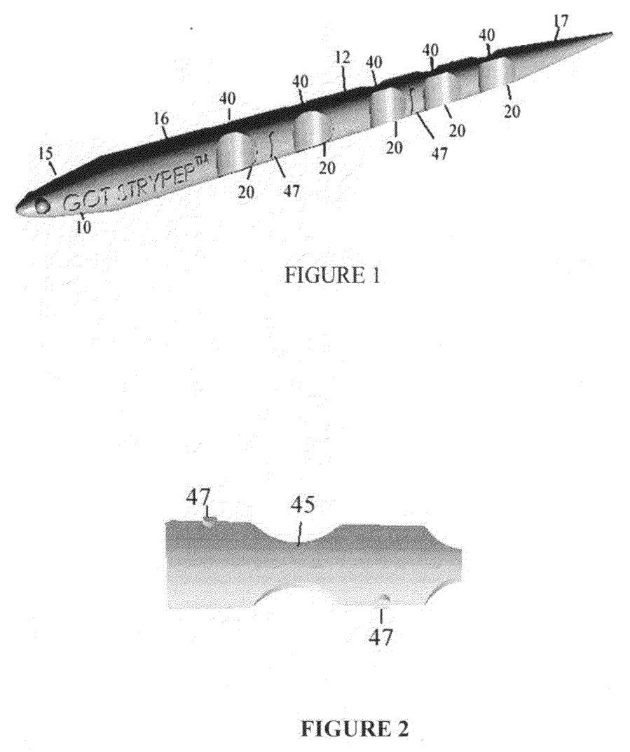

FIG. 2 shows a cross-sectional view of a hinge 40. The vertical stem 45 of the hinge 40 allows for flexure along the vertical axis.

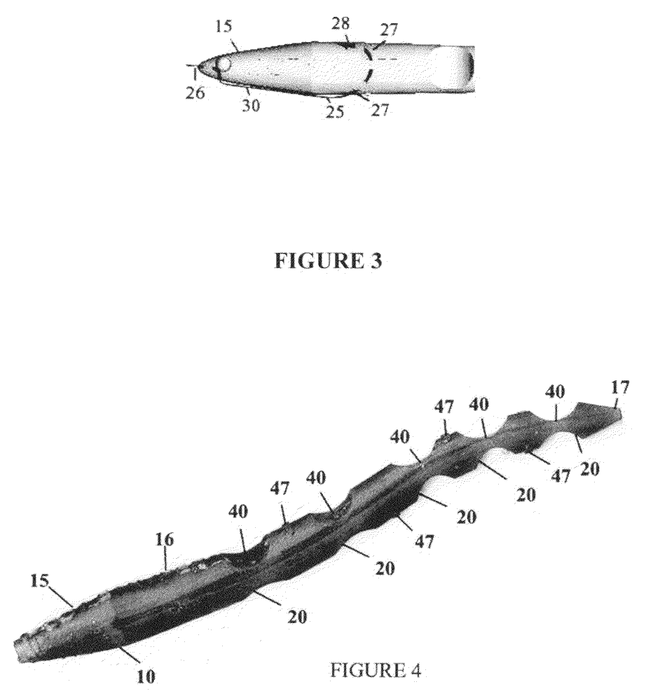

FIG. 3 shows a preferred embodiment of the lure where a hook 30 is placed in the lure. The hook 25 includes a shank 30, line connecting means 26, return bend 27 and barb 28. The return bend 27 terminates in a barb 28 and also preferably passes through a medial portion 16 of the body 12. The line connecting means 26 is offset from the shank 30 and is embedded in the leading end 15 of the body 12 and which shank offset allows the shank 30 to be oriented generally parallel to the body without being embedded into the body. The barb 28 protrudes through the surface and points toward the leading end 15. It is preferred that the barb be nested in close proximity to the back surface to provide additional protection against snagging. The line connecting means or eye 26 is embedded in the leading end 15 of the body and is offset therein. The shank 30 of the hook 25 runs substantially parallel to the longitudinal axis of the body of the lure and is not embedded in the body.

FIG. 4 shows the body in a flexed position. The hinges 40,40 allow for independent motion of the leading and trailing segments respectively. The hinges 40, 40 are shown by way of example flexed in different directions.

In the preferred embodiment, the flexible material is flexible vinyl plastisol, which may be pigmented or colored with polymer materials to lend coloration appropriate to the lure's expressed purposes of imitating natural prey or arousing the response of predatory fish by contrasting with its natural surroundings. The flexible hinges of the lure allow a fairly dense plastisol to be used to fabricate the baits. This provides for a longer usable lifetime when subjected to fish bites. An alternative embodiment is to use a biodegradable based material in place of plastisol. Most biodegradable materials when substituted for plastisol result in a very stiff and inflexible lure. The flexible hinges of the lure allow a fairly rigid biodegradable material to be used to fabricate the baits, while providing significant overall lure flexibility.

The overall buoyancy of the lure may be varied in manufacture by mixing air bubbles or salt into the plastisol material, or by using a flexible material of different specific gravity.

If the lure is made of a transparent or translucent material, the lure acts as a fiber optic. In the case where the lure functions as a fiber optic, light entering the lure is transmitted through the lure and exits at hinge locations and the tail. Light exiting these locations when combined with the serpentine movement of the lure produces a modulated light pattern similar to that of a metal spinner that is frequently combined with fishing lures to provide an attraction for fish.

The combination of rough surfaces (cuts forming hinges and spoilers) causes a mixing action that can activate dinoflagellates into illuminating when passing through a field of bioluminescent organisms. For a transparent or translucent lure, this light can emanate from the hinges or the tail. The lure passing through a field of dinoflagellates gives the appearance of bait fish swimming through the dinoflagellates.

### Operation

FIG. 3 shows one configuration of hooking the lure of the present invention. The lure of the present invention offers the most hook protection, i.e., from getting “snagged” to the bottom surface while fishing. This is due to the breadth and shape of the top surface of the lure. The arrangement of the hook in this manner provides resistance to snags nearly equal to that achieved by concealing the point of the hook inside the body of a plastic lure.

A surprising result observed when using a lure made in this configuration was that a school of small fish was attracted to it, when it was retrieved through the middle of the school. This may have been caused by the modulated light pattern created by the lure that tended to make it look like a part of the school of fish. Retrieving several other types of lures through a school of small fish tended to cause the school to split up and scatter.

As a “weightless” lure, the present invention will swim the surface in a zigzag motion with short jerks of the rod. After the lure is allowed to dive, a twitch of the rod will cause the lure to dart erratically and unpredictably underwater.

Although the description contains many specificities, these should not be construed as limiting the scope of the invention but as merely providing an illustration of a preferred embodiment of the invention. For example, the lure of the present invention can have just one or more than two hinges.

Thus, the invention is described by way of example rather than limitation.

We claim:

1. An artificial fishing lure, comprising:
an elongate, straight line, radially asymmetrical body of soft flexible elastomeric material;
said body having a generally elliptical-shaped cross section the entire length of said body;
said body having a plurality of segments including a leading segment and several trailing segments, each of said segments having a terminating end and a coupling end, and;
a flexible hinge means for coupling said leading segment and trailing segments together at said respective coupling ends, said hinge means comprising predominantly vertical axes of flexure that when combined with spoilers on the trailing segments for imparting a serpentine motion to said plurality of segments as said lure moves through a body of water, said lure moving in a random serpentine manner.

2. An artificial fishing lure as defined in claim 1 wherein said hinge means includes at least two integral hinges, said integral hinges formed by ellipsoidal cuts from the body on opposing sides of said body.

3. An artificial fishing lure as defined in claim 2 wherein said top surface is substantially uninterrupted along the length of said lure and ellipsoidal cuts in the side of the body define flexible hinges.

4. An artificial fishing lure as defined in claim 1 wherein said hinge means comprises a plurality of flexible hinges, said hinges being in a spaced relation to one another and located at the leading of trailing segments of said lure.

5. An artificial fishing lure as defined in claim 1 wherein said body further comprises a medial portion and said leading segment and said trailing segments have cross-sectional areas that radially diminish from said medial portion outwards to said terminating ends of said segments.

6. An artificial lure as defined in claim 1 further comprising a barbed hook partially embedded in said body;
said hook having an arcuate bend terminating in a barb, line connecting means for connecting a fishing line to said hook, a longitudinal shaft for coupling said line connecting means to said barb wherein; said line connecting means is off-set perpendicularly to said shaft;
said hook further being oriented so that said arcuate bend of said hook passes through a medial region of said body;
said hook being further oriented so part of said line connecting means is embedded in said terminating end of said leading segment of said body whereby said longitudinal shaft is not embedded in said body.

7. An artificial fishing lure as defined in claim 1 further including a hook attached to said body wherein the combination of said elastomeric material and hook comprises a unit having a specific gravity slightly greater than the specific gravity of water.

8. An artificial fishing lure as defined in claim 1 wherein said hinges define recesses and spoilers which temporarily trap and release air bubbles when said lure moves in a body of water thereby creating a trailing vortex in the water.

9. A device for attracting fish, said device comprising:
an elongated, straight line, flexible body, said body comprising two terminating ends disposed opposite one another at furthermost points of said body and a plurality of segments displaced along the length of said body and intermediate said two terminating ends, a leading portion of said body comprising a greater average volume per unit length than the rest of said body wherein the cross sectional area of said body, at any point along the length of said body, is bilaterally symmetrical;
a plurality of recesses along the length of said body, said recesses defining areas at which said segments meet
each of said plurality of recesses forming ellipsoidal shape cross sections in said body, said ellipsoidal cut cross sections forming hinges each of which allow flexure about an axis, and
said cross sectional area of said body generally decreasing outwardly from a medial portion of said body to said terminal ends of said body.

10. A device for attracting fish as defined in claim 9 wherein said device has static spoilers on alternating segments transversely projecting from said body.

11. A device for attracting fish as defined in claim 9 wherein said device is an artificial fishing lure.

12. A device for attracting fish as defined in claim 11 wherein said body has an elliptical shaped cross section with the cross section becoming smaller towards one of said terminating ends.

13. A device for attracting fish as defined in claim 12 wherein said device has static spoilers on alternating segments transversely projecting from said body.

14. A device for attracting fish as defined in claim 12 wherein said plurality of recesses form hinges, which allow independent movement of each segment of said plurality of segments.

15. A device for attracting fish as defined in claim 12 wherein said device is transparent or translucent to form a fiber optic body which collects incoming light at the recesses which form hinges and outputs light at other recesses and the tail.
